(19) United States
(12) Patent Application Publication
(10) Pub. No.: US 2021/0165626 A1
(43) Pub. Date: Jun. 3, 2021

(54) MULTI-DISPLAY DEVICE AND METHOD FOR CONTROLLING MULTI-DISPLAY DEVICE

(71) Applicant: NEC Display Solutions, Ltd., Tokyo (JP)

(72) Inventor: Kenji YAMAMOTO, Tokyo (JP)

(21) Appl. No.: 16/071,410

(22) PCT Filed: Jan. 28, 2016
(86) PCT No.: PCT/JP2016/052512

§ 371 Date: Jul. 19, 2018

(51) Int. Cl. G06F 3/14; G09G 5/12

(52) U.S. Cl. CPC G06F 3/1446; G09G 5/12; G09G 2310/08; G09G 2360/04; G09G 2300/026

(57) ABSTRACT

A multi-display device includes a plurality of display devices daisy-chained together. In the multi-display device, the display device includes an image output controller configured to select whether to delay an input video signal by a predetermined period or not according to the position of the display device and to thereby output the input video signal delayed by the predetermined period based on the selected result as an output signal to a next-stage display device.

### TECHNICAL FIELD

The present invention relates to a multi-display device and a method for controlling the multi-display device.

### BACKGROUND ART

In multi-display devices, it is important to eliminate misalignment of images displayed at the seams between upper and lower portions of display devices (hereinafter, referred to as “body cracking”) in order to display a single image using multiple display devices.

Patent Literature Document 1 discloses a technology for a multi-display device to delay the start time of vertical scanning on a display panel, which is disposed at a lower position between two display panels vertically adjoining together, by one frame. According to this technology, it is possible to eliminate the body cracking at the seams between two display panels aligned vertically.

### CITATION LIST

### Patent Literature Document

Patent Literature Document 1: Japanese Patent Application Publication No. 2001-222269

### SUMMARY OF INVENTION

### Technical Problem

However, the multi-display device disclosed by Patent Literature Document 1 includes a single image processor and a plurality of image displays. The image processor carries out a process of converting video signals, which are input into the multi-display device, into signals displayed on multiple image displays. Multiple image displays have their own frame memories, wherein the lower image display delays the start time of vertical scanning for signals processed by the image processor by one frame.

To increase the number of display panels installed in the multi-display device, a process of inputting signals, which are converted by the image processor, into the image displays should be complicated because of additionally implementing a process of selecting the lower image display. To prevent a complicated input process of signals, which are converted by the image processor, into the image displays, the multi-display device disclosed by Patent Literature Document 1 needs to limit the number of display panels (i.e. the number of display panels aligned in a vertical direction) to two.

The problem to be solved by the invention is that the multi-display device is unable to increase the number of display panels. That is, it is an object of the invention to provide a multi-display device and a control method for a multi-display device, which can prevent the occurrence of body cracking at the seams between two display panels vertically adjoining together and which can increase the number of display panels.

### Solution to Problem

The present invention relates to a multi-display device including a plurality of display devices daisy-chained together. In the multi-display device, the display device includes an image output controller configured to select whether to delay an input video signal by a predetermined period or not according to the position of the display device and to thereby output the input video signal delayed by the predetermined period based on the selected result as an output signal to a next-stage display device.

The present invention relates to a control method for a multi-display device including a plurality of display devices daisy-chained together. The control method for the multi-display device includes an image output process in which the display device selects whether to delay an input video signal by a predetermined period or not according to the position of the display device and thereby outputs the input video signal delayed by the predetermined period based on the selected result as an output signal to a next-stage display device.

### Advantageous Effects of Invention

According to the present invention, an image output controller is configured to delay the start time of vertical scanning for a lower display device, which is disposed at a lower position among two display devices which are vertically aligned to form a multi-display device, by one frame. Accordingly, an image processor does not need to carry out a process of selecting a lower image display while an image display carries out a process of converting video signals into signals displayable on a display panel; hence, image displays do not necessarily install a frame memory, and therefore, they do not need to delay the start time of vertical scanning for signals processed by an image processor by one frame. Thus, the image output controller is configured to carry out both the delay processes executed by the image displays and the selecting process of the lower image display executed by the image processor even when the number of display panels is increased in the multi-display device; hence, it is possible to ease restrictions on an input process of signals, which are converted by the image processor, into the image displays. Accordingly, it is possible to prevent the occurrence of body cracking at the seams between two display panels vertically adjoining together irrespective of the increased number of display panels (in particular, even when the number of display panels is increased to three or more). According to the present invention, which relates to a multiple-display device having increased the number of display panels and a control method for the multi-display device, it is possible to prevent the occurrence of body cracking at the seams between two display panels vertically adjoining together.

### BRIEF DESCRIPTION OF DRAWINGS

FIG. 1 is a block diagram showing the configuration of a multi-display device according to one embodiment of the present invention.

FIG. 2 is a block diagram showing the configuration of a display device shown in FIG. 1.

FIG. 3 is a diagram showing an image output controller 23 of the display device shown in FIG. 2.

FIG. 4 is a flowchart showing the processing of the display device shown in FIG. 1.

FIG. 5 is a block diagram showing the configuration of a multi-display device configured to output sound.

### DESCRIPTION OF EMBODIMENT

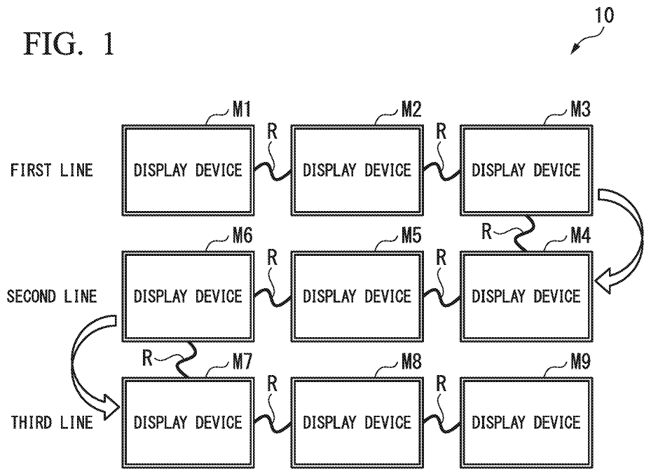

Hereinafter, a multi-display device according to one embodiment of the present invention will be described with reference to drawings. FIG. 1 is a block diagram showing the configuration of the multi-display device according to the embodiment of the present invention.

FIG. 1 shows a configuration example of a multi-display device 10 having multiple display devices daisy-chained together. It shows an example of connecting nine display devices M1, M2, . . . , M9 in a manner of three rows by three columns. That is, the display devices are aligned at positions each represented by the number of rows and the number of columns in a matrix for aligning the display devices. For example, the display device M1 is disposed at first row by first column; the display device M2 is disposed at first row by second column; the display device M3 is disposed at first row by third column Similarly, the display device M4 is disposed at second row by third column; the display device M5 is disposed at second row by second column; the display device M6 is disposed at second row by first column. Similarly, the display device M7 is disposed at third row by first column; the display device M8 is disposed at third row by second column; the display device M9 is disposed at third row by third column.

The display devices are connected together via paths R, e.g. serial cables. As shown in FIG. 1, the display device M1 is connected to the display device M2 via the path R; the display device M2 is connected to the display device M3 via the path R; the display device M3 is connected to the display device M4 via the path R. Thus, it is possible to transmit video signals, displayed on each display device, from the first stage of the display device M1 to the last stage of the display device M9 among the display devices connected together via the paths.

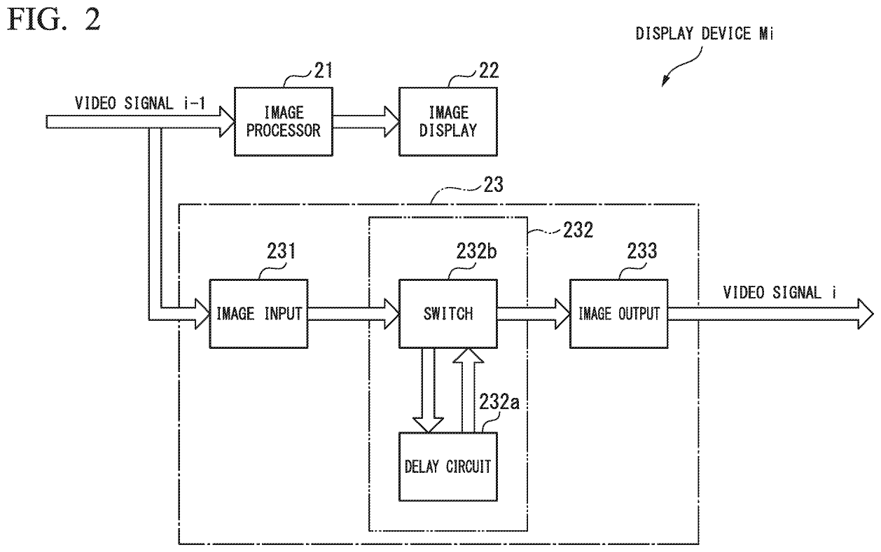

FIG. 2 is a block diagram showing the configuration of the display device shown in FIG. 1. FIG. 2 shows the configuration of a display device Mi with number i (where i equals any number among 1 through 9) counted from the first display device among the display devices M1 through M9 shown in FIG. 1.

The display device Mi inputs and displays a video signal i−1 on a liquid crystal panel of an image display 22. In addition, the display device Mi carries out a process of transmitting or not transmitting the input video signal i−1 through a delay circuit 232a of an image output controller 23, thus producing an output signal after processing as a video signal i to be output to the next stage of the display device, i.e. a display device Mi+1.

The display device Mi includes an image processor 21, the image display 22, and the image output controller 23.

The image processor 21 carries out a process of converting the video signal i−1, which is input to the display device Mi, into a signal to be displayed on the display panel of the image display 22.

The image display 22 including a liquid crystal panel converts the processed signal of the image processor 21 into a signal having a receivable format with the liquid crystal panel, thus providing the signal to the liquid crystal panel.

The image output controller 23 includes an image input part 231, a delay circuit controller 232, and an image output part 233.

The delay circuit controller 232 includes the delay circuit 232a and a switch 232b.

The image input part 231 sends the video signal i−1, which is input to the display device Mi, to the switch 232b of the delay circuit controller 232.

The delay circuit 232a includes a frame memory configured to store data for a predetermined period corresponding to one frame; hence, it produces an output signal by delaying the video signal i−1, which is input to the display device Mi, by the predetermined period corresponding to one frame, thus supplying the output signal to the switch 232b.

The switch 232b selectively makes a decision whether to supply the video signal i−1 input to the display device Mi to the delay circuit 232a according to the selected result.

According to the present embodiment incurring a possibility that each display device may be disposed at an indefinite position changeable in its line number, for example, the image output controller 23 produces the selected result 1 for delaying the input video signal i−1 by the predetermined period corresponding to one frame when the display device M3 is changed in its line number and relocated to the display device M4 or when the display device M6 is changed in its line number and relocated to the display device M7. Alternatively, the image output controller 23 produces the selected result 2 for not delaying the input video signal i−1 when each display device is not changed in position in terms of its line number, for example, when the display device M1 is relocated to the display device M2 without changing its line number, or when the display device M2 is relocated to the display device M3 without changing its line number.

According to the selected result 1, the switch 232b supplies the video signal i−1 input to the display device Mi to the delay circuit 232a, which in turn produces an output signal by delaying the video signal i−1 by the predetermined period corresponding to one frame, and therefore, the delay circuit controller 232 supplies the output signal to the image output part 233.

According to the selected result 2, the switch 232b inhibits the video signal i−1 input to the display device Mi from being supplied to the delay circuit 232a, and therefore, the delay circuit controller 232 directly supplies an output signal, i.e. the video signal i−1 input to the display device Mi, to the image output part 233.

The image output part 233 outputs the output signal of the delay circuit 232, which is given from the switch 232b, to the next stage of the display device, i.e. the display device Mi+1.

As described above, the display device Mi having the aforementioned configuration carries out a process of transmitting or not transmitting the input video signal i−1 through the delay circuit 232a in the image output controller 23, thus producing the processed signal as an output signal to be sent to the next stage of the display device, i.e. the display device Mi+1.

Next, a control operation for the image output controller 23, serving as the technical feature of the display device Mi according to the present invention, will be described with reference to the drawings.

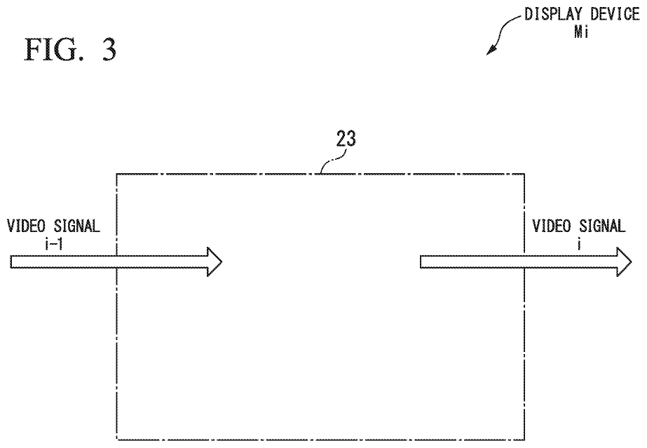

FIG. 3 is a diagram showing the image output controller 23 among the constituent elements of the display device shown in FIG. 2. In FIG. 3, parts identical to those shown in FIG. 2 are denoted using the same reference signs.

The image output controller 23 includes a frame memory configured to store data for a predetermined period corresponding to one frame, and therefore, it produces an output signal by delaying a video signal i−1, which is input to the display device Mi, by the predetermined period corresponding to one frame, and then forwarding the output signal as a video signal i to the next stage of the display device Mi+1.

In addition, the image output controller 23 selects whether to forward the video signal i−1, which is input to the display device Mi, as the video signal i to the next stage of the display device Mi+1 according to the selected result.

In the present embodiment, the image output controller 23 produces the selected result 1 for delaying the input video signal i−1 by the predetermined period corresponding to one frame when the display device is disposed at a position changeable in the line number. Alternatively, the image output controller 23 produces the selected result 2 for not delaying the input video signal i−1 when the display device is disposed at a position unchangeable in the line number.

According to the selected result 1, the image output controller 23 produces an output signal by delaying the video signal i−1 input to the display device Mi by the predetermined period corresponding to one frame, and then forwarding the output signal as the video signal i to the display device Mi+1.

According to the selected result 2, the image output controller 23 produces an output signal as the video signal i−1 input to the display device Mi, and then forwarding the output signal as the video signal i to the display device Mi+1.

### First Embodiment

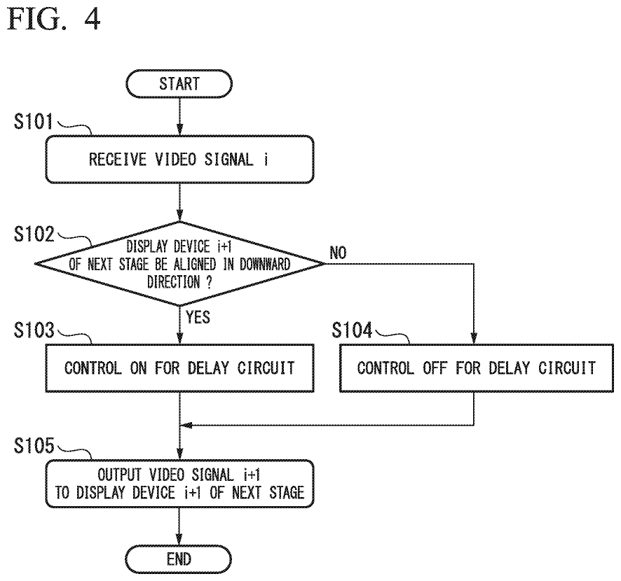

Returning back to FIG. 1, the operation of the multi-display device 10 including a plurality of display devices M1 through M9 daisy-chained together will be described with reference to FIG. 4. FIG. 4 is a flowchart showing the processing of the display device Mi shown in FIG. 1.

As shown by arrow symbols in FIG. 1, the delay circuit controller 232 carries out a one-frame delay process with respect to the display device M3 and M6. The processing of the display device Mi (where i=3, 6) will be described below.

The image input part 231 of the display device Mi receives a video signal i (step S101).

The image output controller 23 of the display device Mi determines whether the next stage of the display device Mi+1 is disposed in a lower direction or not (step S102). Specifically, the image output controller 23 produces the selected result 1 or 2 upon selecting whether the input video signal i−1 should be delayed or not according to the position of the display device.

The image output controller 23 of the display device Mi produces the selected result 1 for delaying the input video signal i−1 because the display device Mi is disposed at the position changeable in the line number (step S102—Yes).

The delay circuit controller 232 of the display device Mi controls the delay circuit 232a to be turned on (step S103). Specifically, the switch 232b sends the video signal i−1 input to the display device Mi to the delay circuit 232a, which in turn delays the video signal i−1 by one frame so as to supply an output signal to the image output part 233.

The image output part 233 of the display device Mi sends the video signal i to the next stage of the display device Mi+1 (step S105).

The delay circuit controller 232 bypasses a delay process and therefore does not involve in frame delay with respect to the display devices M1-M2, the display devices M4-M5, and the display devices M7-M9. The processing of the display device Mi (where i=1-2, 4-5, 7-9) will be described below.

The image input part 231 of the display device Mi receives a video signal i (step S101).

The image output controller 23 of the display device Mi determines whether the next state of the display device Mi+1 is disposed in a lower direction or not (step S102). Specifically, the image output controller 23 produces the selected result 1 or 2 upon selecting whether the input video signal i−1 should be delayed by the predetermined period or not according to the position of the display device.

The image output controller 23 of the display device Mi produces the selected result 2 for not delaying the input video signal i−1 because the display device Mi is disposed at the position unchangeable in the line number (step S102—No).

The delay circuit controller 232 of the display device Mi controls the delay circuit 232a to be turned off (step S104). Specifically, the switch 232b produces an output signal as the video signal i−1 input to the display device Mi without conducting the input video signal i−1 of the display device Mi to the delay circuit 232a, and then supplying the output signal to the image output part 233.

The image output part 233 of the display device Mi sends the video signal i to the next stage of the display device Mi+1 (step S105).

As a result, the display devices M4, M5, M6 disposed at the second line counted from the uppermost position carry out rendering with one-frame delaying of images after the rendering of the display devices M1, M2, M3 disposed at the first line; hence, it is possible to eliminate body cracking between the display devices disposed at the upper and lower positions. Since the delay circuit controller 232 of the display device M6 carries out a one-frame delay process as well, it is possible to eliminate body cracking between a series of display devices M4, M5, M6 and a series of display devices M7, M8, M9.

As described above, the multi-display device 10 of the present invention is a multi-display device including a plurality of display devices M1 through M9 daisy-chained together, wherein the display device Mi selects whether to delay the input video signal i−1 by the predetermined period or not according to the position of the display device, and therefore, the display device Mi includes the image output controller 23 configured to forward an output signal as a video signal i to the next stage of the display device.

The image output controller 23 of the multi-display device 10 includes the delay circuit 232a configured to produce an output signal by delaying an input video signal by the predetermined period, and the switch 232b configured to determine whether to supply the input video signal to the delay circuit 232a or not according to the selected result.

The position of the display device Mi located in the multi-display device 10 is represented by the line number and the column number in a matrix for aligning a plurality of display devices. When the display device is disposed at the position changeable in the line number, the display device produces an output signal by delaying the input video signal i−1 by the predetermined period, and then forwarding the output signal as the video signal i to the next stage of the display device.

In the multi-display device 10, the predetermined period is a delay time corresponding to one frame of the input video signal.

According to the present invention in which the image processor 21 does not carry out a process of selecting the lower stage of the image display while the image display 22 carries out a process of converting video signal into signal displayable on the display panel, the image display 22 does not need to install a frame memory, and therefore, it is unnecessary to delay the start time of vertical scanning on the processed signals of the image processor 21 by one frame. For this reason, even when the number of display panels is increased in the multi-display device 10, it is possible to ease restrictions on the image processor 21 implementing the input process of the converted signals into the image display 22 because the image output controller 23 carries out both the delay process executed by the image display 22 and the selecting process of selecting the lower image display 22 executed by the image processor 21. Therefore, it is possible to prevent the occurrence of body cracking at the seams between two display panels vertically adjoining together even when the number of display panels is increased to a larger number (in particular, increased to three or more). According to the present invention, it is possible to prevent the occurrence of body cracking at the seams between two display panels vertically adjoining together in the multi-display device, which includes the increased number of display panels, and the control method of the multi-display device.

In this connection, it is possible to make settings for determining “whether the next stage of the display device Mi+1 is disposed in the lower direction or not” as shown in FIG. 4 according to the intention of the user setting up the multi-display device 10, however, it is possible to automatically control settings with respect to the multi-display device 10 using software applications.

Even when a plurality of display devices having different frame delay values are aligned in a horizontal direction, it is possible to eliminate misalignment of displayed images by controlling the delay circuit 232a based on delay values. In the case of a delay difference of one frame or more, for example, it is possible to mount multiple frame memories on the delay circuit 232a, or it is possible to interpose multiple frame memories each configured to delay signal by one frame between the display devices.

### Second Embodiment

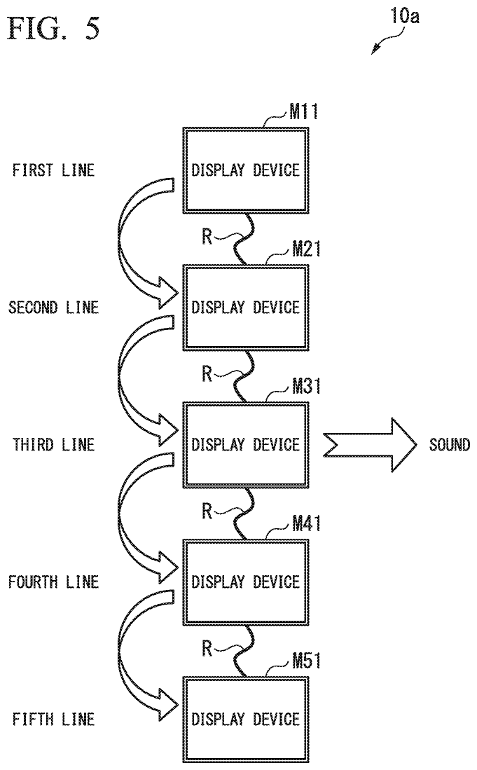

FIG. 5 is a block diagram showing the configuration of a multi-display device configured to produce sound. FIG. 5 shows a configuration example of a multi-display device 10a including a plurality of display devices daisy-chained together. It uses an example of five display devices M11, M12, M13, M14, and M15 which are aligned in five rows by one column and connected together via paths R. That is, the display device M11 is disposed at one row by one column; the display device M12 is disposed at second row by one column; the display device M13 is disposed at third row by one column; the display device M14 is disposed at fourth row by one column; the display device M15 is disposed at fifth row by one column

As shown by arrow symbols in FIG. 5, the delay circuit controller 232 carries out a one-frame delay process with respect to the display devices M11 through M14.

According to the multi-display device 10a similar to the multi-display device 10 of the first embodiment, it is possible to carry out a delay processes for multiple display devices simply using a one-frame memory. Similar to the multi-display device 10 of the first embodiment, it is possible to prevent images from being displayed in a zigzag manner because video signals are sequentially delayed in the order from the uppermost display device to the lowermost display device, and therefore, it is possible to smoothly display images entirely on multiple display devices. That is, it is possible to prevent the occurrence of body cracking at the seams between two display devices vertically adjoining together.

As to time lags between sounds produced by five display devices vertically aligned as shown in FIG. 5, for example, it is possible to average delay values by producing sound from the intermediate display device, i.e. the display device M31 disposed at the third row; hence, it is possible to produce sound without any discomfort of hearing due to a reduction of time lags between sounds entirely.

The present invention has been described above with reference to the preferable embodiments, but the present invention is not necessarily limited to the foregoing embodiments and variations. That is, it is possible to think out other variations by adding, omitting, and replacing some configurations in the foregoing embodiments without departing from the essential matter of the invention. In addition, the present invention is not necessarily limited to the foregoing descriptions, but the present invention would be limited within the scope of the appended claims.

### INDUSTRIAL APPLICABILITY

According to the multi-display device of the foregoing embodiments, it is possible to prevent the occurrence of body cracking at the seams between two display panels vertically adjoining together, and therefore, it is possible to provide the multi-display device having increased the number of display panels.

### REFERENCE SIGNS LIST

10 multi-display device
21 image processor
22 image display
23 image output controller
231 image input part
232 delay circuit controller
233 image output part
232a delay circuit
232b switch
M1, M2, M3, M4, M5, M6, M7, M8, M9, M11, M12, M13, M14, M15 display device
R path

1. A multi-display device including a plurality of display devices daisy-chained together,
wherein each display device includes an image output controller configured to select whether to delay an input video signal by a predetermined period or not according to a position of each display device and to thereby output the input video signal delayed by the predetermined period based on a selected result as an output signal to a next-stage display device.

2. The multi-display device according to claim 1, wherein the image output controller further includes a delay circuit configured to produce the output signal by delaying the input video signal by the predetermined period, and
a switch configured to select whether to supply the input video signal to the delay circuit or not according to the selected result.

3. The multi-display device according to claim 1, wherein the image output controller selects to delay the input video signal by the predetermined period when the next-stage display device is disposed in a lower direction than each display device.

4. The multi-display device according to claim 1, wherein the plurality of display devices are aligned in a matrix so that a position of each display device is defined by a line number and a column number of the matrix, and wherein each display device outputs the input video signal delayed by the predetermined period as the output signal to the next-stage display device when each display device is disposed at a position changeable in the line number.

5. The multi-display device according to claim 1, wherein the predetermined period corresponds to one frame of the input video signal.

6. A control method for a multi-display device including a plurality of display devices daisy-chained together, comprising: selecting whether to delay an input video signal by a predetermined period or not according to a position of each display device: and outputting the input video signal delayed by the predetermined period based on a selected result as an output signal to a next-stage display device.
